(19) United States
(12) Patent Application Publication
(10) Pub. No.: US 2021/0081821 A1
(43) Pub. Date: Mar. 18, 2021

(54) INFORMATION PROCESSING DEVICE AND INFORMATION PROCESSING METHOD

(71) Applicant: NIPPON TELEGRAPH AND TELEPHONE CORPORATION, Tokyo (JP)

(72) Inventors: Taku SASAKI, Musashino-shi (JP); Keita MIKAMI, Musashino-shi (JP); Kunihiro MORIGA, Musashino-shi (JP)

(73) Assignee: NIPPON TELEGRAPH AND TELEPHONE CORPORATION, Tokyo (JP)

(21) Appl. No.: 16/971,313

(22) PCT Filed: Mar. 14, 2019
(86) PCT No.: PCT/JP2019/010714

§ 371 Date: Aug. 20, 2020

(30) Foreign Application Priority Data
Mar. 16, 2018 (JP) 2018-050181

(51) Int. Cl. G06N 5/04; G06N 20/00

(52) U.S. Cl. CPC G06N 5/04; G06N 20/00

(57) ABSTRACT

An information processing device (10) predicts a ratio (scale) of features to input data, and, when the predicted scale is equal to or smaller than a predetermined value, divides the input data and outputs the divided data to an analysis device (20). When the predicted scale is significantly smaller than the predetermined value, the information processing device (10) also divides the input data into smaller pieces as the scale is smaller, and outputs the pieces to the analysis device (20). The information processing device (10) also predicts a scale of the features with respect to the input data by machine learning using training data.

### TECHNICAL FIELD

The present invention relates to an information processing device and an information processing method.

### BACKGROUND ART

There is conventionally a technique of dividing data that has been input into an important part (features) and an unimportant part (background). For example, a technique using deep learning ignores the background of image data to detect only the features, thereby enabling an analysis of the features. This technique has the following two advantages.
High accuracy (due to not being influenced by the background i.e., noise)
High processing speed (due to not performing the background evaluation)

The above technique is applicable to, for example, the analysis of an object, e.g., a person, an animal, a moving object, or the like that appears in an image or a video captured by a monitoring camera.

In addition, an EDRAM (Enriched Deep Recurrent visual Attention Model) is known as a technique of analyzing an object appearing in a video or an image, as described above. The EDRAM is a technique of moving a frame for capturing an object part in an input image or an input video, and analyzing a region of the frame cut out each time the frame is moved.

Here, for an image, the frame can move in two directions of vertical and horizontal directions, and for a video, in three directions with the time axis added to the vertical and horizontal ones. Further, the frame may move to a position such that the frame includes an object in an image or a video therein. Here, the region of the frame cut out is analyzed, for example, by the following classification and crosschecking of the object. Note that the following is an example of classification and crosschecking when the object is a person.
Classification: Estimating the attributes of the person (e.g., gender, age, clothes worn, etc.)
Crosschecking: Determining whether the given person is the same person

Note that the above classification includes estimating a variety of information and states related to the person, such as motion of the person, in addition to estimating the attributes of the person.

Further, the EDRAM is composed of, for example, the following four neural networks (NNs).
Initialization NN: NN for determining the first frame
Core NN: NN for “memorizing” what the frame has seen in the past
Move NN: NN for moving the frame to an optimal position based on the memory
Analysis NN: NN for outputting an analysis result based on the memory

FIG. 12 illustrates the relationship between the four NNs.

In the initialization NN of the EDRAM, when an image 101 including a person, for example, is acquired, the first frame for the image 101 is determined and cut out. Then, the position of the frame cut out (e.g., the first frame illustrated in FIG. 12) is memorized in the core NN, the region in the first frame is analyzed in the analysis NN, and the analysis result is output (e.g., thirties, female, etc.).

After that, in the movement NN, the frame is moved to an optimum position. For example, in the movement NN, the frame is moved to the position of the second frame illustrated in FIG. 12. Then, the position of the frame cut out after the movement (e.g., the second frame) is memorized in the core NN, the region in the second frame is analyzed in the analysis NN, and the analysis result is output.

After that, the frame is moved to a more optimal position in the movement NN. For example, in the movement NN, the frame is moved to the position of the third frame illustrated in FIG. 12. Then, the frame cut out after the movement (e.g., the third frame) is memorized in the core NN, the region in the third frame is analyzed in the analysis NN, and the analysis result is output.

With the EDRAM repeating such processes, the frame is narrowed down gradually so that the frame converges on the whole body of the person in the image 101 finally. Therefore, in the EDRAM, it is important that the frame generated by the initialization NN includes a person in order for the frame to converge on the whole body of the person in the image. In other words, if the frame (first frame) generated in the initialization NN does not include a person, it is difficult to find a person no matter how many times the frame is narrowed down in the movement NN.

Here, an experiment was conducted, and the result of the experiment was obtained such that, when an image group to be handled in the EDRAM has the multi-scale property, the initialization of a frame including a person often fails. The multi-scale property here is a property wherein the size (scale) of a person appearing is different depending on images. For example, as illustrated in FIG. 13, when the size (scale) of each person in an image group is different, the image group has the multi-scale property.

When an image group to be handled in the EDRAM has a multi-scale property, the initialization of a frame including a person may fail, and as a result, the analysis accuracy of persons in the image may be reduced.

This will be described with reference to FIG. 14. For example, when an image group to be handled in the EDRAM is data set A in which the scales of persons in all images are almost the same, after several trainings, there will be a high probability that the first frame initialized in the EDRAM includes a person or persons. That is, initialization such that a person is included can be performed with a high likelihood. On the other hand, when an image group to be handled in the EDRAM is data set B in which the scales of persons are different depending on images, after no matter how many times of training, it is highly unlikely that the first frame initialized in the EDRAM includes a person. That is, initialization to include a person with a high probability is not possible. As a result, the analysis accuracy of the person in the image may be reduced.

Note that, when an image group to be handled in the EDRAM has the multi-scale property, the reason why the initialization of a frame including a person fails is believed to be as follows.

For example, as illustrated in images 201, 202 and 203 of data set B in FIG. 14, when the scale of the person in the image 203 is smaller than the scales of the persons in the images 201 and 202, the EDRAM is affected by the images 201 and 202 such that the EDRAM generates a similar first frame for the image 203 such as by including a person of a similar scale. As a result, it is expected that, the EDRAM generates the first frame in a place different from the person for the image 203 (see the frame indicated by reference numeral 204).

### CITATION LIST

### [Non Patent Literature]

[NPL 1] Artsiom Ablavatski, Shijian Lu, Jianfei Cai, “Enriched Deep Recurrent Visual Attention Model for Multiple Object Recognition”, IEEE WACV 2017, 12 Jun. 2017

### SUMMARY OF THE INVENTION

### Technical Problem

In an analysis device that extracts and analyzes features from input data as well as the above-described EDRAM, when the input data has the multi-scale property, the initialized first frame may not include the features. Therefore, it may not be possible to accurately analyze the input data. Accordingly, an object of the present invention is to solve the above-described problem and accurately analyze features of input data even when the input data has the multi-scale property.

### Means for Solving the Problem

In order to solve the above-described problem, the present invention is an information processing device that performs pre-processing on data used in an analysis device that extracts and analyzes features of data. The information processing device includes an input unit that accepts an input of the data; a prediction unit that predicts a ratio of the features to the data; a division method determination unit that determines a division method for the data according to the predicted ratio; and a division execution unit that executes division for the data based on the determined division method.

### Effects of the Invention

According to the present invention, even when the input data has the multi-scale property, it is possible to accurately analyze the features of the input data.

### BRIEF DESCRIPTION OF DRAWINGS

FIG. 1 is a diagram illustrating a configuration example of a system.

FIG. 2 illustrates examples of training data.

FIG. 3 illustrates examples of image data.

FIG. 4 illustrates the description of an example of division of image data.

FIG. 5 is a flowchart illustrating an example of a processing procedure of the system.

FIG. 6 illustrates the description of an example of division of image data.

FIG. 7 illustrates the description of detection of a person part in a window sliding method.

FIG. 8 illustrates the description of framing of a person part in YOLO (You Only Look Once).

FIG. 9 illustrates the description of features and scale for input data which is audio data.

FIG. 10 illustrates the description of features and scale for input data which is time-series sensor data.

FIG. 11 is a diagram illustrating an example of a computer that executes an information processing program.

FIG. 12 is a diagram for describing an example of processing by the EDRAM.

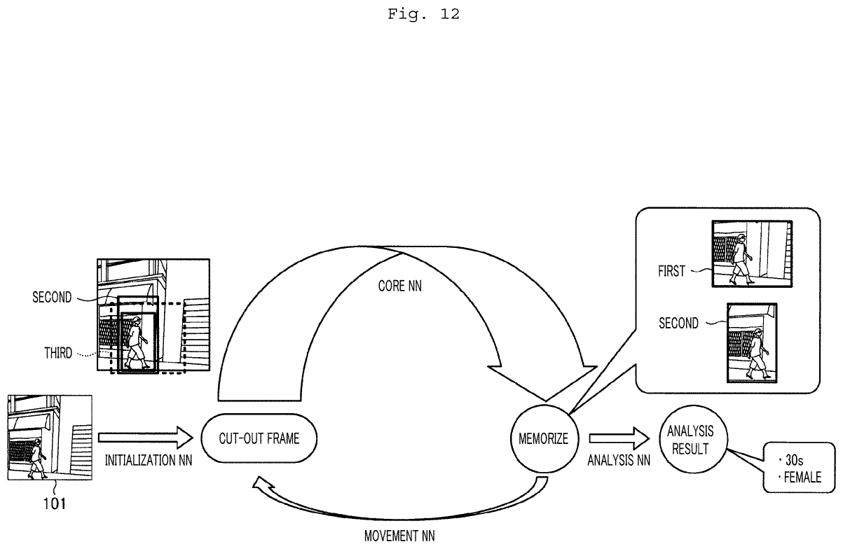

FIG. 13 illustrates an example of an image group having the multi-scale property.

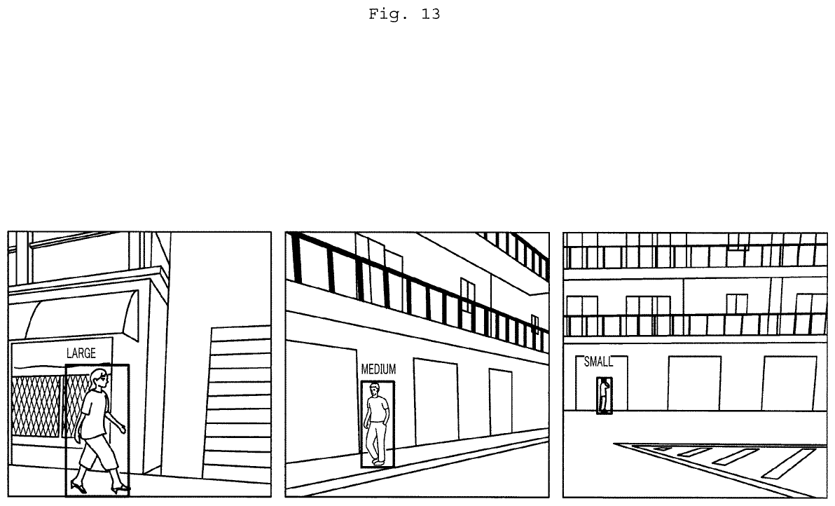

FIG. 14 illustrates the description of initialization of a frame including a person in the EDRAM.

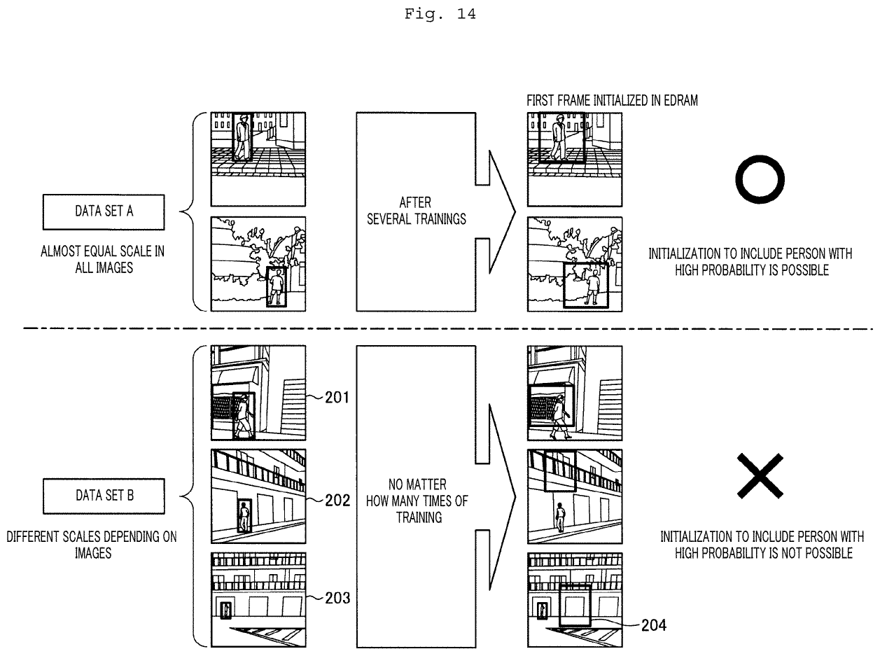

### DESCRIPTION OF EMBODIMENTS

### Overview

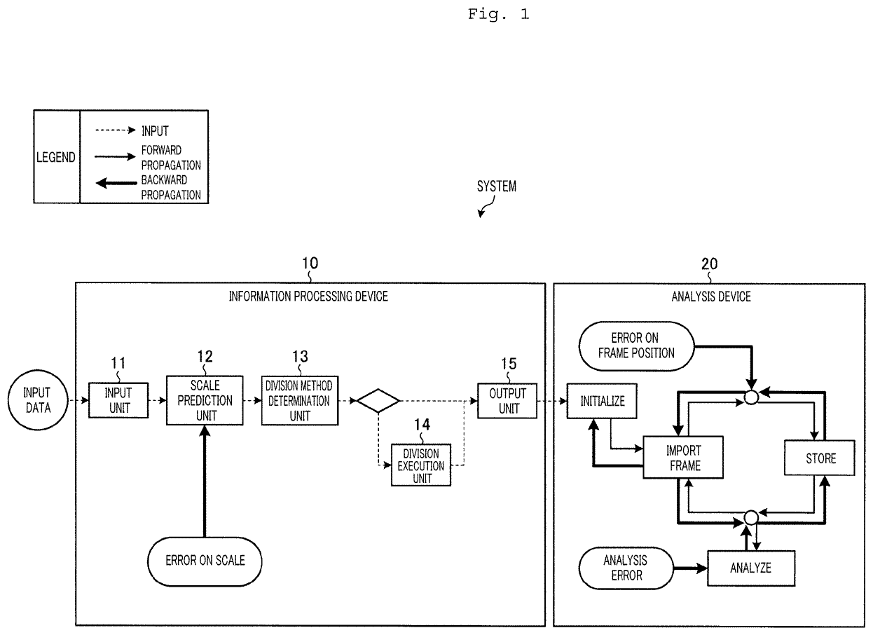

Hereinafter, embodiments of the present invention will be described with reference to the drawings. To begin with, an overview of a system including an information processing device of an embodiment will be described with reference to FIG. 1.

The system includes an information processing device 10 and an analysis device 20. The information processing device 10 pre-processes data (input data) to be handled by the analysis device 20. The analysis device 20 analyzes the input data pre-processed by the information processing device 10. For example, the analysis device 20 extracts features of the input data on which the pre-processing has been performed by the information processing device 10, and analyzes the extracted features.

For example, when the input data is image data, the features of the input data is, for example, a person part of the image data. In this case, the analysis device 20 extracts a person part from the image data that has been pre-processed by the information processing device 10, and analyzes the extracted person part (e.g., estimates the gender, age, etc. of the person corresponding to the person part). The analysis device 20 performs analysis using, for example, the above-described EDRAM. Note that, when the input data is image data, the features of the input data may be other than a person part, and may be, for example, an animal or a moving object.

Note that the input data may be video data, text data, audio data, or time-series sensor data, other than the image data. Note that, in the following description, a case where the input data is image data will be described.

In accordance with the above-described EDRAM, the analysis device 20 for example initializes the frame based on the input data which has been pre-processed by the information processing device 10, stores the previous frames as memory, narrows down and analyzes the frame based on the memory, updates the parameters of each NN based on errors on the position of the frame and the analysis, and the like. An NN is used for each processing, and the process results of each NN propagate forward and backward, for example, as illustrated in FIG. 1.

Note that, instead of or in addition to the above-described EDRAM, the analysis device 20 may extract and analyze the features from the input data by a sliding window method (described later), YOLO (You Only Look Once, described later), or the like.

Here, the information processing device 10 divides the input data based on a prediction result of a ratio (scale) occupying a ratio of the features to the input data.

For example, the information processing device 10 predicts the ratio (scale) of the features to the input data, and if the predicted scale is equal to or smaller than a predetermined value (e.g., if the person part serving as the features in the image data is small), a predetermined division is performed on the input data. Then, the information processing device 10 outputs the divided input data to the analysis device 20. On the other hand, if the predicted scale is equal to or smaller than the predetermined value (e.g., if the person part serving as the features in the image data is small), the information processing device 10 outputs the input data to the analysis device 20 without performing division.

Thus, the variations in the scales of the data input to the analysis device 20 can be reduced as much as possible, so that the analysis device 20 can accurately analyze the features of the input data.

### Configuration

Subsequently, a configuration of the information processing device 10 will be described with reference to FIG. 1. The information processing device 10 includes an input unit 11, a scale prediction unit (prediction unit) 12, a division method determination unit 13, a division execution unit 14, and an output unit 15.

The input unit 11 accepts an input of input data. The scale prediction unit 12 predicts a ratio (scale) of the features to the input data accepted by the input unit 11. For example, if the input data (image data) includes a person, the scale prediction unit 12 predicts what scale the person is likely to appear. For the scale prediction performed here, machine learning is used, for example. As the machine learning, an NN is used, for example. The NN allows more accurate prediction of the scale of unknown input data by learning with pairs of the input data and its scale.

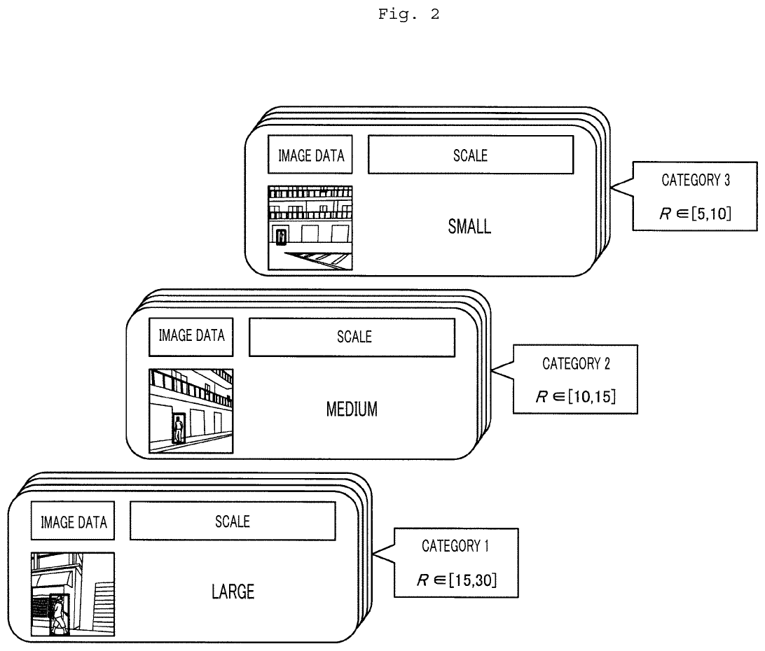

Here, an example of training data used for learning with the NN will be described with reference to FIG. 2. For example, as illustrated in FIG. 2, a data set in which input data (image data) is associated with a scale of features (person part) in the image data is prepared as training data.

Here, for a ratio (scale, R) of the features (person part) to the image data, as an example, a data set of three categories is prepared: R∈[15, 30] (category 1: scale “Large”), R∈[10, 15] (category 2: scale “Medium”), and R∈[5, 10] (category 3: scale “Small”). Then, the scale prediction unit 12 predicts the scale in a manner of updating the parameters of the NN so as to fit the data set and determining which of scale “Large”, scale “Medium”, and scale “Small” as described above the input data (image data) to be predicted belongs to.

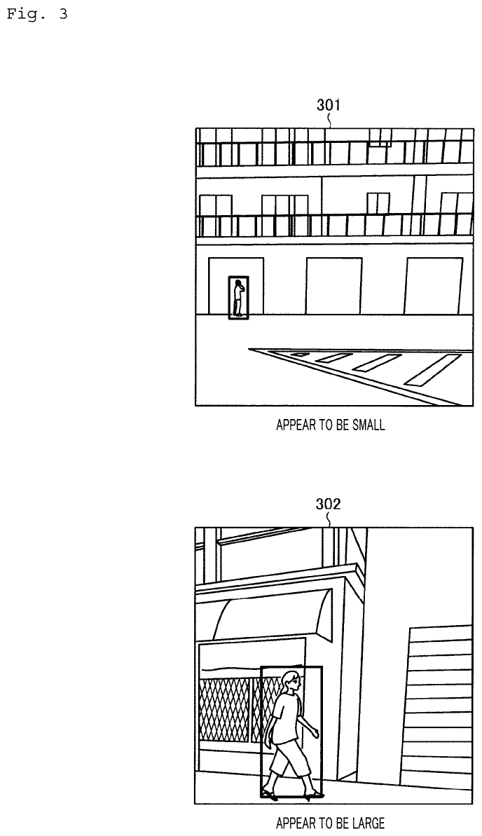

For example, consider cases where the input data is image data indicated by reference numeral 301 and image data indicated by reference numeral 302 in FIG. 3. In the cases, using the results of the above machine learning, the scale prediction unit 12 predicts “a scale of small” for the image data in which a person appears to be small as illustrated by reference numeral 301, and predicts “a scale of large” for the image data in which a person appears to be large as illustrated by reference numeral 302.

Note that the scale prediction unit 12 may directly predict the value of the scale (R) without categorizing the scale (R) of the input data into large, medium, small, and the like.

Note that it is assumed that, when the input data is image data including a background, the NN that implements the scale prediction unit 12 determines whether the input data (image data) is of wide-angle photography or telephotography based on the size of a building or the like which is the background of the features of the image data or the like, and makes use of the results for accurate scale prediction.

The division method determination unit 13 in FIG. 1 determines a method of dividing the input data (division method), that is, whether to divide the input data, or when dividing the input data, how many segments the input data is to be divided into, how to divide, and the like. For example, the division method determination unit 13 determines whether or not the input data needs to be divided according to the scale of the input data predicted by the scale prediction unit 12, and further determines, if the input data needs to be divided, how many segments the input data is to be divided into, how to divide, and the like. Then, the division method determination unit 13 outputs the input data and the division method to the division execution unit 14. On the other hand, if the division method determination unit 13 determines that division of the input data is unnecessary, the division method determination unit 13 outputs the input data to the output unit 15.

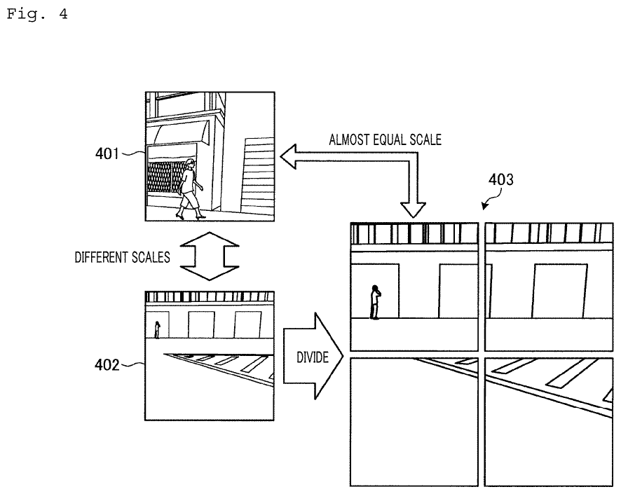

For example, as illustrated in FIG. 4, the division method determination unit 13 determines that image data 402 in which the scale of the features (person part) is equal to or smaller than a predetermined value is divided into four segments as indicated by reference numeral 403. Note that the division method determination unit 13 may determine that the smaller the scale of the input data is, the finer the input data is divided. For example, if the scale of the input data predicted by the scale prediction unit 12 is significantly smaller than the above-described predetermined value, it may be determined that the input data is divided into more smaller pieces according to the small scale. Then, the division method determination unit 13 outputs the image data 402 and the determination result of the number of segments of the image data 402 to the division execution unit 14.

On the other hand, as illustrated in FIG. 4, the division method determination unit 13 determines that the division is not performed on the image data 401 in which the scale of the features (person part) exceeds the predetermined value. Then, the division method determination unit 13 outputs the image data 401 to the output unit 15.

Note that the scale prediction unit 12 may be implemented by an NN. In this case, the scale prediction unit 12 accepts an error between the scale predicted by the scale prediction unit 12 and the actual scale. Then, the scale prediction unit 12 adjusts parameters used for scale prediction based on the error. Repeating such processing makes it possible for the scale prediction unit 12 to more accurately predict the scale of the input data.

The division execution unit 14 in FIG. 1 divides the input data based on the division method determined by the division method determination unit 13. Then, the division execution unit 14 outputs the divided input data to the output unit 15. For example, the division execution unit 14 divides the image data 402 in FIG. 4 into four segments as indicated by reference numeral 403, and outputs all partial images as the segments to the output unit 15.

The output unit 15 outputs the input data output from the division execution unit 14 and the division method determination unit 13 to the analysis device 20. For example, the output unit 15 outputs the image data 402 (see reference numeral 403 in FIG. 4) divided into four by the division execution unit 14 and the image data 401 output from the division method determination unit 13 to the analysis device 20.

### Processing Procedure

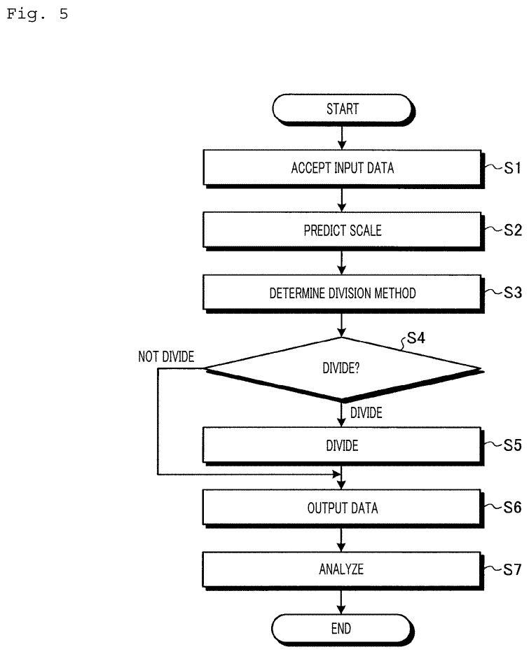

Next, a processing procedure of the system will be described with reference to FIG. 5. First, the input unit 11 of the information processing device 10 accepts input data (S1). Next, the scale prediction unit 12 predicts the scale of the input data (S2). Then, based on the scale of the input data predicted in S2, the division method determination unit 13 determines whether or not to divide the input data and, if the input data is to be divided, determines how finely the input data is to be divided (S3: determine a division method).

As the result of determining the division method in S3, if it is determined that the input data accepted in S1 is not to be divided (“not divide” in S4), the division method determination unit 13 outputs the input data to the analysis device 20 via the output unit 15 (S6: output the data). On the other hand, as the result of determining the division in S3, if it is determined that the input data accepted in S1 is to be divided (“divide” in S4), the division execution unit 14 performs a predetermined division on the input data based on the determination result by the division method determination unit 13 (S5). Then, the division execution unit 14 outputs the divided input data to the output unit 15. Then, the output unit 15 outputs the divided input data to the analysis device 20 (S6: output the data). After S6, the analysis device 20 analyzes the data output from the information processing device 10 (S7).

In such an information processing device 10, if the scale of the input data is equal to or smaller than the predetermined value, it is possible to perform division according to the scale and then output the data to the analysis device 20. Thus, even when input data group has the multi-scale property, it is possible to make the scale of the data group to be input to the analysis device 20 as equal as possible. As a result, the analysis device 20 can improve the analysis accuracy of the features in the input data.

### Other Embodiments

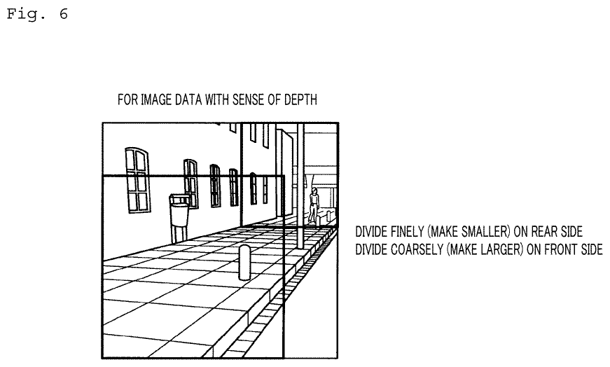

Note that, when the input data is image data having a sense of depth as illustrated in FIG. 6, the division method determination unit 13 may determine a division method such that a distant view part is divided as a distant view part and a near view part is divided as a near view part. For example, the division method determination unit 13 may determine a division method such that a part on the rear side in the image illustrated in FIG. 6 is divided finely (makes it smaller) and a part on the front side is divided coarsely (makes it larger). In this way, even when the input data includes image data having a sense of depth, it is possible to make the scale of the data to be input to the analysis device 20 as equal as possible.

Further, the analysis device 20 is not limited to the above-described device using the EDRAM as long as it can extract features from the input data and analyzes them. For example, the analysis device 20 may be a device that extract features from the input data and analyzes them by the sliding window method, YOLO, or the like.

For example, when the analysis device 20 is a device that extracts features (person part) from the input data (e.g., image data) by the sliding window method, the analysis device 20 extracts the person part from the image data and analyzes it as follows.

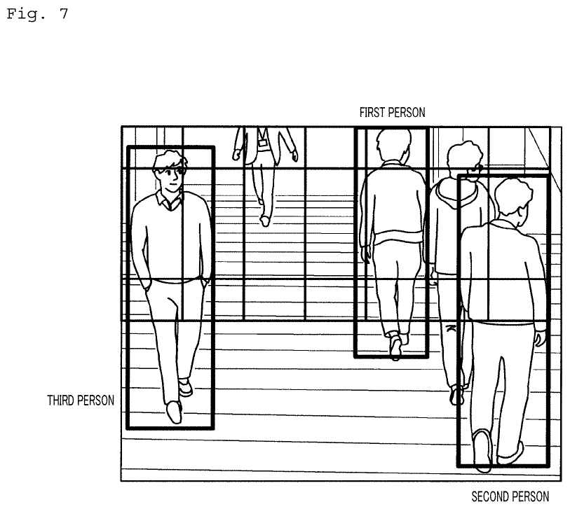

That is, the analysis device 20 using the sliding window method prepares frames (windows) of several types of sizes, slides the frames on image data, and performs a full scan to detect and extract a person part. Thus, the analysis device 20 detects and extracts, for example, the first, second, and third person parts from the image data illustrated in FIG. 7. Then, the analysis device 20 analyzes the extracted person parts.

In the sliding window method, since processing of adjusting the sizes of the frames is not performed, a person who appears to be large in the image cannot be detected unless a large frame is used, and a person who appears to be small in the image cannot be detected unless a small frame is used. Then, unsuccessful detection of the person part results in a reduced analysis accuracy of the person part.

Accordingly, the analysis device 20 using the sliding window method accepts pieces of data (image data) with a scale as equal as possible from the information processing device 10 described above, thereby making it easy to prepare a frame with an appropriate size for the image data. As a result, the analysis device 20 easily detects the person part from the image data, and thus it is possible to improve the analysis accuracy of the person part in the image data. Further, since the analysis device 20 does not need to prepare frames of various sizes for the image data, it is possible to reduce the processing load required when detecting a person part from the image data.

Further, for example, when the analysis device 20 is a device that extracts a person part, which is features, from the input data (e.g., image data) and analyzes it by YOLO, the analysis device 20 extracts the person part, which is features, from the image data and analyzes it as follows.

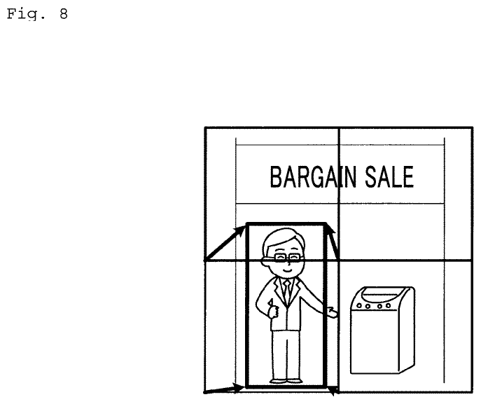

That is, the analysis device 20 using YOLO divides the image data into grids to look for a person part as illustrated in FIG. 8. Then, when the analysis device 20 finds a person part, the analysis device 20 fits the frame to the person part. Here, when the analysis device 20 using YOLO finds the person part from the image data but fails to fit the frame to the person part, the detection of the person part will not be successful, and as a result, the analysis accuracy of the person part will also be reduced.

Accordingly, the analysis device 20 using YOLO accepts pieces of data (image data) with a scale as equal as possible from the information processing device 10 described above, thereby making it easy to detect a person part from the image data. As a result, it is possible to improve the analysis accuracy of the person part in the image data.

Further, as described above, the input data to be handled in the system may be video data, text data, audio data, or time-series sensor data, other than the image data.

For example, when the input data is text data, the features is, for example, a specific word, phrase, expression, or the like in the text data. Therefore, when the input data is text data, the information processing device 10 uses, as a scale of the input data, for example, a ratio of the number of characters in the above-described features to the number of all characters in the entire text data.

Then, the information processing device 10 divides the text data as necessary so that the ratio (scale) of the number of characters of the above-described features to the number of all characters of the entire text data is as equal as possible, and outputs the divided data to the analysis device 20.

In this way, when the analysis device 20 is an analysis device that analyzes a specific word, phrase, expression, or the like in text data, it is possible to improve the analysis accuracy.

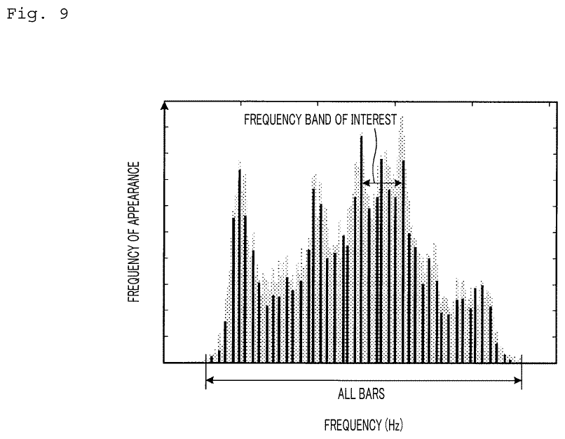

Further, for example, when the input data is audio data, the features include, for example, a human voice in audio data with background noise and a specific word or phrase in audio data, a voice of a specific person, a specific frequency band and the like, without background noise. Therefore, when the input data is audio data, the information processing device 10 uses, as the scale of the input data, for example, an SN ratio (Signal-to-Noise ratio) of the human voice to the audio data, or the length of time for a particular word or phrase relative to the total length of time for the entire audio data. Further, when a specific frequency band in audio data is used, the information processing device 10 uses, as the scale of the input data, for example, a width of a specific frequency band with respect to all bars of a histogram indicating an appearance frequency for each of the frequency bands included in the audio data (see FIG. 9).

Then, the information processing device 10 divides the audio data as necessary so that the ratio (scale) of the features (the SN ratio of a human voice, the length of time of a specific word or phrase, and the width of a specific frequency band) to the entire audio data is as equal as possible, and outputs the divided data to the analysis device 20.

In this way, when the analysis device 20 analyzes a human voice, a specific word or phrase, a voice of a specific person, a specific frequency band, and the like in audio data, it is possible to improve the analysis accuracy.

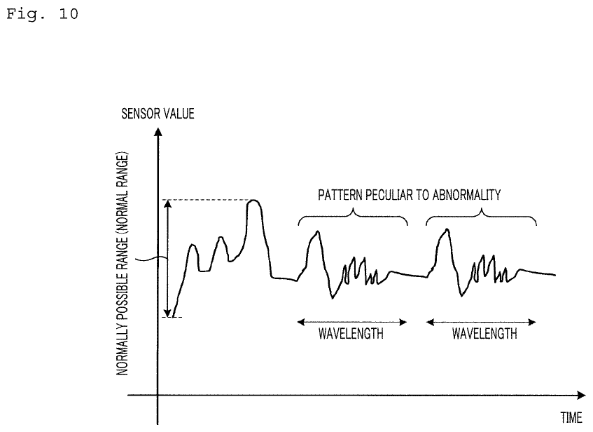

Further, when the input data is time-series sensor data, the features include, for example, a sensor value pattern indicating some abnormality and the like. As an example, the sensor value itself is in a normally possible range (normal range), but it may have a repeated pattern peculiar to an abnormality (see FIG. 10). In such a case, in order to detect and analyze the abnormality, a part which is in a normal range of the sensor value itself but indicates a pattern peculiar to the abnormality in the time-series sensor data is used as the features.

Therefore, when the input data is time-series sensor data, the information processing device 10 uses, as the scale of the input data, for example, a frequency of a part which is in a normal range of the sensor value itself but indicates a pattern peculiar to an abnormality in the time-series sensor data (see FIG. 10). Then, the information processing device 10 divides the time-series sensor data as necessary so that the ratio (scale) of the wavelength of the features (the part which is in a normal range of the sensor value itself but indicates a pattern peculiar to an abnormality) to the entire time-series sensor data is as equal as possible, and outputs the divided data to the analysis device 20.

In this way, when the analysis device 20 detects and analyzes an abnormality from time-series sensor data, it is possible to improve the analysis accuracy.

Further, the input data may be a video image (image data). In this case, the features include, for example, a frame in a video image in which a person makes a specific motion. Then, the information processing device 10 divides the frame of the video image as necessary so that the ratio (scale) of the features (the frame in the video image in which a person makes a specific motion) to the number of all frames of the entire video image is as equal as possible, and outputs the divided frames to the analysis device 20.

In this way, when the analysis device 20 analyzes a frame in a video image in which a person makes a specific motion, it is possible to improve the analysis accuracy.

### Program

Further, the functions of the information processing device 10 described in the above embodiment can be implemented by installing a program for realizing the functions on a desired information processing device (computer). For example, by causing the information processing device to execute the above-described program provided as package software or online software, the information processing device can function as the information processing device 10. The information processing device referred to here includes a desktop or laptop personal computer, a rack-mounted server computer, and the like. The information processing device also includes a mobile communication terminal such as a smartphone, a mobile phone, and a PHS (Personal Handyphone System), and also a PDA (Personal Digital Assistants) and the like. Further, the information processing device 10 may be implemented in a cloud server.

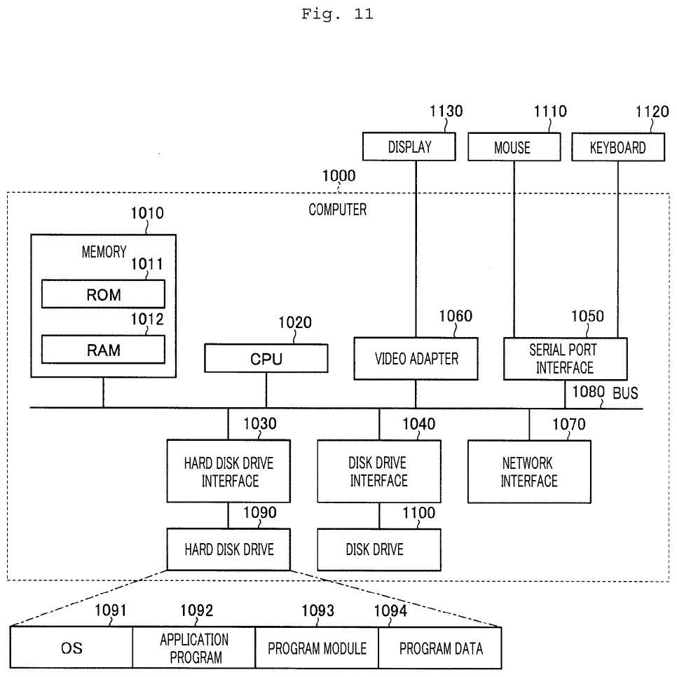

An example of a computer that executes the above program (information processing program) will be described with reference to FIG. 11. As illustrated in FIG. 11, the computer 1000 includes, for example, a memory 1010, a CPU 1020, a hard disk drive interface 1030, a disk drive interface 1040, a serial port interface 1050, a video adapter 1060, and a network interface 1070. These components are connected by a bus 1080.

The memory 1010 includes a ROM (Read Only Memory) 1011 and a RAM (Random Access Memory) 1012. The ROM 1011 stores, for example, a boot program such as a BIOS (Basic Input Output System). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

Here, as illustrated in FIG. 11, the hard disk drive 1090 stores, for example, an OS 1091, an application program 1092, a program module 1093, and program data 1094. The various data and information described in the above embodiment are stored in, for example, the hard disk drive 1090 and the memory 1010.

Then, the CPU 1020 loads the program module 1093 and the program data 1094 stored in the hard disk drive 1090 into the RAM 1012 as necessary, and executes the processes in the above-described procedures.

Note that the program module 1093 and the program data 1094 according to the above information processing program are not limited to being stored in the hard disk drive 1090. For example, the program module 1093 and the program data 1094 according to the above program may be stored in a removable storage medium and read out by the CPU 1020 via the disk drive 1100 or the like. Alternatively, the program module 1093 and the program data 1094 according to the above program may be stored in another computer connected via a network such as a LAN or a WAN (Wide Area Network), and read out by the CPU 1020 via the network interface 1070. Further, the computer 1000 may execute the processing using a GPU (Graphics Processing Unit) instead of the CPU 1020.

### REFERENCE SIGNS LIST

10 Information processing device
11 Input unit
12 Scale prediction unit
13 Division method determination unit
14 Division execution unit
15 Output unit
20 Analysis device

1. An information processing device that pre-processes data used in an analysis device that extracts and analyzes features of data, the information processing device comprising: an input unit that accepts an input of the data; a prediction unit that predicts a ratio of the features to the data; a division method determination unit that determines a division method for the data according to the predicted ratio; and a division execution unit that divides the data based on the determined division method.

2. The information processing device according to claim 1, wherein the prediction unit predicts, for each data, a ratio of the features to the data by machine learning using training data indicating a ratio of the features to the data.

3. The information processing device according to claim 1, wherein the division method determination unit determines that the data is to be divided when the ratio of the features to the data is equal to or smaller than a predetermined value.

4. The information processing device according to claim 1, wherein the division method determination unit determines that the data is to be divided into smaller pieces as the ratio of the features to the data is smaller.

5. The information processing device according to claim 1, wherein the data is image data or video data, and the features include a part of an object that appears in the image data or the video data.

6. The information processing device according to claim 1, wherein the data is text data, and the features include a predetermined keyword included in the text data.

7. The information processing device according to claim 1, wherein the data is audio data, and the features include one of a human voice, a voice of a specific person, a voice indicating a predetermined word, and a voice with a predetermined frequency band, included in the audio data, or a combination thereof.

8. The information processing device according to claim 1, wherein the data is time-series sensor data, and the features include a pattern of a predetermined sensor value included in the time-series sensor data.

9. An information processing method executed by an information processing device that pre-process data used in an analysis device that extracts and analyzes features of data, the information processing method comprising the steps of: accepting an input of the data; predicting a ratio of the features to the data; determining a division method for the data according to the predicted ratio; and dividing the data based on the determined division method.
